(19) United States
(12) Patent Application Publication
(10) Pub. No.: US 2023/0017136 A1
(43) Pub. Date: Jan. 19, 2023

(54) AUTOMATIC PLANT CULTIVATION DEVICE

(71) Applicants: Artem BARDIZ, Sverdlovsk region (RU); Nikolay SAMOLOVOV, Sverdlovsk region (RU); Vadim KHARRASOV, San Donato Milanese (MI) (IT)

(72) Inventors: Artem BARDIZ, Sverdlovsk region (RU); Nikolay SAMOLOVOV, Sverdlovsk region (RU); Vadim KHARRASOV, San Donato Milanese (MI) (IT)

(21) Appl. No.: 17/948,516

(22) Filed: Sep. 20, 2022

(30) Foreign Application Priority Data
Jul. 1, 2021 (RU) 2021119272

(51) Int. Cl. A01G 9/24; A01G 7/04

(52) U.S. Cl. CPC A01G 9/247; A01G 7/045; A01G 9/249

(57) ABSTRACT

The invention relates to the field of soil and ionitoponic (ionitoponics) automated cultivation of plants having various morphological structures and can be applied in everyday life. The technical result to be achieved by the invention is to ensure a balanced growth and development of plants without human intervention. The essence of the invention is that a plant cultivation device comprises a plant cultivation chamber and the following controller-operated modules: a lighting module, a ventilation module, a substrate humidity monitoring module, an irrigation module, a module for monitoring a water level in a reservoir, and a plant growth stage monitoring module. The device further comprises: a controller-operated plant cultivation module comprising a container and a substrate provided with all necessary micro—, macroelements and microorganisms to achieve the best plant growth; a substrate humidity monitoring module; and a means for differentiating air flows.

### FIELD OF THE INVENTION

The invention relates to the field of soil and ionitoponic (ionitoponics) automated cultivation of plants having various morphological structures and can be applied in everyday life.

### BACKGROUND OF THE INVENTION

The prior art discloses a plant cultivation device comprising a housing accommodating a lighting module, a filtration module, and a plant cultivation module (RU 188785, application: 2018114290, 18 Apr. 2018).

The prior art discloses a plant cultivation device comprising a housing accommodating a lighting module, a filtration module and a plant cultivation module equipped with a means for hydroponically supplying substances to a root zone (US 2014259920, publication date: 18 Sep. 2014, IPC: A01G1/00).

The prior art discloses a plant cultivation device comprising a housing accommodating a controller, a lighting module, a ventilation module and a plant cultivation module equipped with a means for aeroponically supplying substances to a root zone (WO 2017207508, publication date: 7 Dec. 2017, IPC: AO1G31/06).

The plant cultivation device which comprises the housing accommodating the lighting module, the filtration module and the plant cultivation module (RU 188785, application: 2018114290, 18 Apr. 2018) has been selected as the closest analogue for the invention.

The disadvantage of the closest analogue and the known technical solutions is the presence of a favorable environment for breeding microorganisms. Since this environment is favorable for the development of microorganisms, various units (flaps, gate valves, valves, pumps, a breeding unit (one or more open or closed containers of any shape and size), a pipeline) will overgrow and operate incorrectly.

The favorable environment can also facilitate the development of not only beneficial microorganisms, but also pathogenic flora which in turn can lead to plant diseases and death.

The technical problem to be solved by the invention is to increase the efficiency of plant cultivation and obviate the need for any maintenance and control.

The technical result to be achieved by the invention is to ensure a balanced growth and development of plants without human intervention.

### SUMMARY OF THE INVENTION

To achieve the above-indicated technical result, a plant cultivation device is provided, which comprises a housing accommodating a plant cultivation chamber, a lighting module, a ventilation module, and a plant growth stage monitoring module, the modules being operated by a controller. The lighting module is arranged inside the plant cultivation chamber. The device further comprises a plant cultivation module operated by the controller and filled with a substrate, and a substrate moisture monitoring module. The plant cultivation module is configured to automatically irrigate the substrate based on substrate moisture data received from the substrate moisture monitoring module. The plant cultivation module may be filled with the enriched and/or ionitoponic substrate. Unlike the closest analogue, the device comprises the plant cultivation module which comprises: a container having ventilation holes and drainage holes to remove excess water, the substrate moisture monitoring module, irrigation pipelines, and the substrate provided with all necessary micro—, macroelements and microorganisms to achieve the best plant growth. The substrate may be different types of soil mixtures: mineral, organic and organo-mineral, as well as the substrate may comprise a mineral matrix or synthetic ion-exchange resins. Ion exchangers are configured to withhold and retain all nutrients (K, Ca, Mg, Fe and SO₃ ions, etc.), gradually giving them to the roots of plants in order to exchange them for the waste products of the plants which are secreted by the roots. In this case, irrigation should be carried out with clean water. The exchange between the ions of the substrate and the roots proceeds in the aquatic environment.

The rate of ion exchange depends on a number of complex biochemical processes occurring in a plant organism, i.e., on temperature, humidity, illumination, plant development phases. Since all the nutrients are in the substrate, this allows one to significantly simplify the procedure for feeding the plant, as well as to spend much less time caring for the plant due to the gradual dosing of the nutrients contained in the substrate.

To provide the full growth and development of the plant, it is necessary to monitor the moisture of the substrate (by using a substrate moisture sensor) and timely irrigate the substrate via the controller according to a predefined algorithm from a water storage tank with the aid of an irrigation module (submersible, peristaltic or other pump).

The plant cultivation chamber is a space within the device, in which the plant cultivation module with seeds and/or shoots is inserted. The plant cultivation chamber is shaped and sized to accommodate plants, as well as to ensure their further growth and development.

The ventilation module is configured to provide supply-and-exhaust ventilation of the plant cultivation chamber and a technical compartment. The ventilation module comprises climate control elements configured to control air parameters inside the plant cultivation chamber. The climate control elements may be temperature, humidity and/or air velocity sensors, as well as air substance sensors, light sensors, pressure sensors. The climate control elements may be installed inside the ventilation module and/or inside the plant cultivation chamber.

The ventilation module may comprise a circuit for air circulation inside the plant cultivation chamber and a circuit for air exchange with the ambient environment. The circuit for air circulation inside the plant cultivation chamber and the circuit for air exchange with the ambient environment may be connected by means of air ducts, while a system of controllable fans operated by the controller may be used to change the amount of air entering the plant cultivation chamber. The circuit for air circulation inside the plant cultivation chamber comprises a fan, a module for feeding plants with carbon dioxide and a system of air ducts connected to the plant cultivation chamber, as well as an air purification module which may comprise ionization and air filtration elements, including photocatalytic filters configured to purify the air leaving out.

The device may further comprise a means for humidifying air flows, which is configured to change the humidity and temperature of the air inside the plant cultivation chamber by adding fine liquid particles to it. The means for humidifying the air flows may comprise a liquid supply module and a fluid spray module. The liquid supply module may be a submersible peristaltic or other pump arranged in or near a liquid reservoir. The liquid spray module may be nozzles or atomizers, which may be arranged inside the plant cultivation chamber.

The humidifying means may be equipped with a heat exchange unit which is configured to provide evaporative cooling and increase the efficiency of changing the humidity and temperature of the air inside the plant cultivation chamber. For example, the heat exchange unit may be a perforated plate or heat exchanger which is equipped with fans blowing liquid from its surface. The means for humidifying the air flows may be integrated into the ventilation module.

The device may further comprise a means for differentiating air flows, which is configured to simulate natural wind flows inside the plant cultivation chamber by changing the speed and direction of the air flows, thereby strengthening a stem and increasing the efficiency of nutrient intake. The means for differentiating the air flows may receive data from the climate control elements. The means for differentiating the air flows may comprise an air blowing module and an air guiding module. The air blowing module may be a compressor and a receiver or a fan, or the fans of the ventilation module may be used as the air blowing module. The air guiding module may be an air duct of any shape and size, which is connected to the plant cultivation chamber and having a controlled-damper deflector at its end. In this case, the controllable deflector may have a telescopic flexible structure to allow the air flows to be guided to certain parts of plants. Furthermore, the circuit for air circulation inside the plant cultivation chamber, which is included in the ventilation module, may be used as the air guiding module.

The plant growth stage monitoring module is configured to monitor the dynamics of plant growth and development in the plant cultivation chamber. In particular, it is configured to signal the start of plant training. The plant growth stage monitoring module may comprise optical and sound control elements. The optical control elements may be a video camera, photo sensor, ultraviolet or infrared sensors, etc. The sound control elements may be ultrasonic distance sensors of various ranges. The plant growth stage monitoring module may be installed anywhere in the plant cultivation chamber, provided that the plants are within the radius of its operation.

The lighting module is configured to create necessary light conditions for plant growth and development inside the plant cultivation chamber. The lighting module may be a panel equipped with LED lamps of various spectrums, for example, ultraviolet, blue, green, yellow, orange, red, far red, infrared and white LEDs, which are configured to differentiate a spectrum and light intensity to make changes in the morphological structure of plants. The lighting module may be of any shape and size and may be installed anywhere in the device, provided that the number of light rays hitting the plants is sufficient for the photosynthesis process. The lighting module may be movably fixed by any known means, for example, by means of hinges, drives or slot systems. The lighting module is operated by the controller whose algorithm automatically adjusts a radiation intensity, desired spectra depending on a plant growth stage, sunrise/sunset simulation, temperature inside the chamber, and other data.

The plant cultivation module is configured to accommodate a plant root system and supply water to the plant root system. The plant cultivation module comprises: a unit for accommodating the plant root system, which is filled with a substrate representing various types of soil mixtures: mineral, organic, organo-mineral and mineral matrices or synthetic ion-exchange resins which are chemically resistant, non-decomposing at normal temperature and under the influence of light and oxygen, with the mineral matrices and ion-exchange resins being saturated with nutrients in accordance with the biological needs of a culture for the entire growing season; a unit for supplying water to the plant root system; and a module (sensor) for measuring a substrate moisture. The unit for accommodating the plant root system may be containers of any shape and size, which are selected in accordance with the size of plant roots and have drainage holes. The unit for supplying water may comprise hoses, a pipeline, etc., equipped with a pump for water supply from the water storage tank.

The controller is configured to process information coming from electronic components of the device and provide the interaction between the electronic components to ensure the plant growth and development in the plant cultivation chamber. The controller may be represented by a set of integrated circuits, chips, and microprocessors.

The housing is shaped and sized to accommodate the plant cultivation chamber and the other structural elements of the device. The housing may comprise upper and lower technological compartments arranged around the plant cultivation chamber. In this case, the ventilation module may be arranged in the upper technological compartment, while the plant cultivation module may be arranged in the lower technological compartment. The housing may comprise holes on the outside, which allow air to be drawn in and out by the ventilation module, as well as allow the air heated by the lighting module to exit. The housing may comprise a door, including an automatically opening one. The housing may comprise input devices that allow one to change and select plant cultivation programs. The input devices may be represented by keys, a touch-screen panel, or may be controlled via a smartphone using wireless technology wi-fi, bluetooth, etc.

The structural elements of the device may be made of any structural materials, such as metal, plastic or composite materials.

The invention has a previously unknown set of essential features, which is characterized in that the device comprises the plant cultivation module comprising the container and the substrate provided with all necessary micro, macroelements and microorganisms to achieve the best plant growth, which requires irrigation with clean water, and excess water drains back to the original water tank. After the maturation of the plant, there is no need to extract it, the device automatically switches from a cultivation mode to a storage mode. To start a new cycle, it is enough to replace the plant cultivation module with a new one.

The presence of the new distinctive essential features indicates the compliance of the invention with the patentability requirement of “novelty”.

The invention may be made of known materials by using known means, which indicates the compliance of the invention with the patentability requirement of “industrial applicability”.

### BRIEF DESCRIPTION OF THE DRAWING

The invention is explained by the FIG. 1 in which:

FIG. 1— housing;

FIG. 2— door;

FIG. 3— touch-screen control panel;

FIG. 4—air outlet;

FIG. 5— installation site for a filter;

FIG. 6—installation site for a plant cultivation module;

FIG. 7—space for a clean water container.

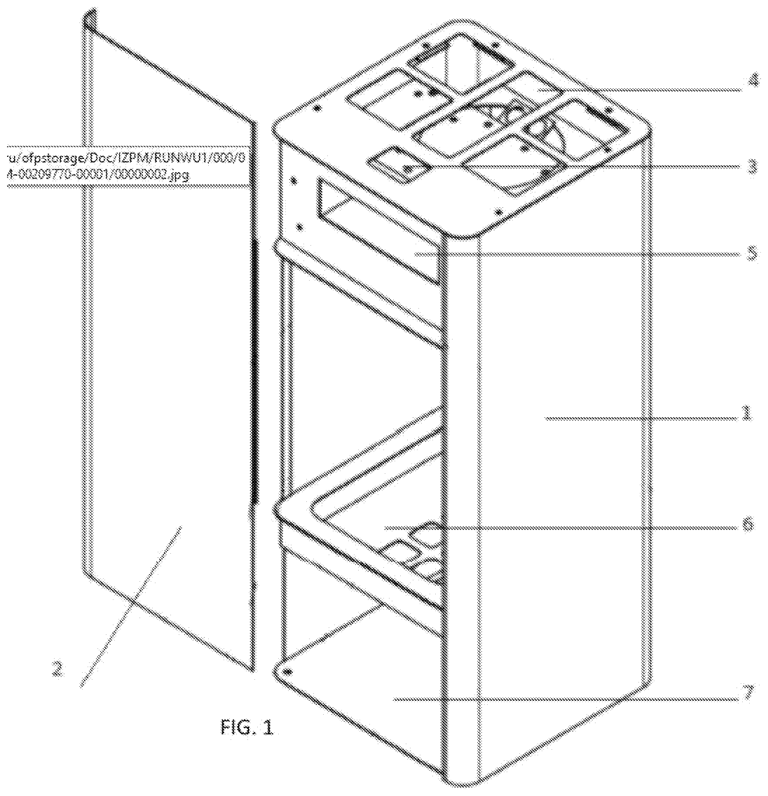

### DETAILED DESCRIPTION OF THE INVENTION

A plant cultivation device comprises a housing 1 configured as a cabinet having a door 2 (in the figure, the door is located separately) and a touch-screen control panel 3. In this case, the housing has an air inlet (not shown in the figure) and a purified-air outlet 4 on the outside. The upper part of the housing has an installation site 5 for a filter, and the central part of the housing has an installation site 6 for a plant cultivation module, under which there is a space 7 for a clean water container.

The invention operates as follows.

The door of the plant cultivation device is opened, filters are installed, clean water is poured, a seed is inserted into the plant cultivation module, and the module itself is installed in a plant cultivation chamber, a substrate moisture monitoring sensor is connected through a connector, with the sensor being in a substrate. By using the touch-screen panel, data on a type of planted plants are entered into a controller. The controller selects a required program for plant care at all stages of their growth.

The plant cultivation module receives a command from the controller and starts cultivation programs.

A water level sensor reports a moisture level of the substrate to the controller, and the controller, if required, sends a signal to a pump to start irrigation. At the same time, according to a given algorithm, lighting (a required spectrum and intensity) is turned on, depending on a plant growth stage. The heat generated by a lighting module is removed through a hole in the plate cultivation chamber. Depending on temperature and humidity, the controller adjusts a lighting intensity, a fan speed, an irrigation level.

When a certain height is reached, a plant growth sensor sends a signal to the controller, whereupon the controller displays, on a screen, a message that, if desired, it is possible to start the plant training (pruning, pinching, etc.).

The lighting module has diodes of various spectra. According to the algorithm, the diodes shine with a certain intensity spectrum and schedule at a certain plant growth stage.

The controller sends, based on the algorithm, a signal to turn on the LEDs of the light spectrum required at this plant growth stage, thereby forming a required luminous flux and light composition to accelerate a set of vegetative mass by the plant, as well as to increase the height and thickness of its stem. When the cultivation cycle ends, the controller turns off the light, irrigation, while maintaining ventilation to remove moisture/odors, and then proceeds to storage, if required.

Thus, the technical result is achieved, which consists in ensuring a balanced growth and development of plants, thereby increasing the efficiency of their cultivation.

1. A plant cultivation device comprising:
a housing accommodating a plant cultivation chamber, a lighting module, a ventilation module, and a plant growth stage monitoring module, the modules being operated by a controller, and the lighting module being arranged inside the plant cultivation chamber;
wherein the device further comprises:
a plant cultivation module operated by the controller and filled with a substrate;
a substrate moisture monitoring module; and
a means for differentiating air flows that is configured to simulate natural wind flows inside the plant cultivation chamber;
wherein the plant cultivation module is configured to automatically irrigate the substrate based on substrate moisture data received from the substrate moisture monitoring module.

2. The plant cultivation device of claim 1, wherein the plant cultivation module is filled with the enriched substrate.

3. The plant cultivation device of claim 1, wherein the plant cultivation module is filled with the ionitoponic substrate.
